(19) United States
(12) Patent Application Publication
(10) Pub. No.: US 2007/0279941 A1
(43) Pub. Date: Dec. 6, 2007

(54) Illumination system and liquid crystal display apparatus

(75) Inventor: Yoshitugu Koshio, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KANAGAWA (JP)

(21) Appl. No.: 11/802,325

(22) Filed: May 22, 2007

(30) Foreign Application Priority Data
May 30, 2006 (JP) 2006-150417

(51) Int. Cl. F21V 7/04

(52) U.S. Cl. 362/623

(57) ABSTRACT

A pressing protrusion is provided to a light source. An area of a reflector in the proximity of a color-mixing light guide plate is pressed by the pressing protrusion so as to cause the reflector to securely touch the color-mixing light guide plate. Moreover, the reflector is provided with guides at both ends thereof. Furthermore, the chassis is provided with a reflector support which touches the guide of the reflector on the liquid crystal display panel side. The reflector support of the chassis receives the guides of the reflector to enable the reflector to slide in substantially parallel to the liquid crystal display panel.

### BACKGROUND OF THE INVENTION

1. Field of the Invention

The present invention relates to an illumination system and a liquid crystal display apparatus, and particularly to an illumination system using a light guide plate and a liquid crystal display apparatus equipped with the illumination system.

2. Description of the Related Art

A liquid crystal display (LCD) apparatus is widely used as a monitor of OA (office automation) equipment, a television set, and the like because of the characteristics including small size, thin shape, and low power consumption. The LCD apparatus is constructed of a liquid crystal display (LCD) panel, a backlight unit, and the like. In the LCD panel, a liquid crystal material is sandwiched by transparent substrates therebetween, and the transparent substrates are facing to each other. The backlight unit generates a backlight to illuminate the LCD panel.

The backlight unit may include a system in which the light emitted from a light source is reflected using a reflector and then diffused using a diffuser to illuminate the LCD panel, a system in which the light emitted from the light source is caused to enter a light guide plate to diffuse therein to illuminate the LCD panel, or a system in which the light source is placed in the entire area of the back surface of the LCD panel to illuminate the LCD panel. The system in which the light emitted from the light source is caused to enter the light guide plate to diffuse therein to illuminate the LCD panel will hereinafter be referred to as a light guide plate system. A thin-shaped LCD apparatus usually utilizes a backlight unit using the light guide plate system.

The backlight unit using the light guide plate system described above is constructed of a light guide plate, a light source, a reflector and a reflection sheet. The light guide plate is made of a transparent plastic resin such as an acrylic resin. Examples of the light source include a Light Emitting Diode (LED) or a cold cathode fluorescent lamp which are disposed on a side surface of the light guide plate. The reflector reflects the light emitted from the light source to the light guide plate. The reflection sheet is disposed to the side surface of the light guide plate opposite to the LCD panel, and reflects the light leaked from the light guide plate for reentering the light guide plate. Such a backlight unit is proposed in Japanese Patent Application Laid-open Publication No. 2003-279985.

In the backlight unit, it is important to effectively use the light which the light source emits. However, in the backlight unit using the light guide plate system, a problem is known that the light is leaked from the gap between the reflector and the other optical member, for example, the light guide plate, resulting in reduced efficiency of utilizing the light.

### SUMMARY OF THE INVENTION

Accordingly, an exemplary feature of the invention is to provide an illumination system which makes it possible to prevent a light from leaking from the gap between the reflector which reflects the light emitted from a light source and a light guide plate, and an LCD apparatus equipped with the illumination system.

The illumination system of the present invention includes: a light source disposed on and facing to the back surface of an irradiated body, and extending in a predetermined direction in a plane substantially parallel to the irradiated body; a first reflector reflecting a light from the light source; a first light guide plate disposed in substantially parallel to the irradiated body to guide the light from the first reflector, the end of which first light guide plate on the incident side is inserted into an opening of the first reflector on the emission side; a second reflector reflecting the light from the first light guide plate; a second light guide plate disposed in substantially parallel to the irradiated body, and guiding the light from the second reflector; a chassis supporting at least the first reflector, the first light guide plate, the second reflector and the second light guide plate; and a protrusion provided to any of the light source and a support member of the light source to press an area of the first reflector in the proximity of the first light guide plate toward the first light guide plate.

Preferably, the protrusion is molded to any of the light source and the support member of the light source in a single piece.

Preferably, the first reflector includes: a first surface provided with an opening through which the light source is inserted; a second surface which is connected with one side of the first surface, and which extends toward the back surface of the first light guide plate; and a third surface which is connected with one side opposite to the above-mentioned one side of the first surface, and which extends toward the front surface of the first light guide plate. The protrusion presses the second surface toward the third surface side to narrow the space between the second surface and the third surface.

Preferably, the first reflector includes guides at both ends located in the predetermined direction, the guide projecting in the predetermined direction. The chassis to support both ends of the first reflector includes a reflector support having a flat section which is substantially parallel to the irradiated body, and which touches the guide on the irradiated body side. The reflector support engages with the guide, thereby the first reflector is restricted from moving toward the irradiated body side, and is able to slide in the direction substantially perpendicular to the predetermined direction in the plane substantially parallel to the irradiated body.

Preferably, the guide is molded to the first reflector in a single piece, and the reflector support is molded to the chassis in a single piece.

Preferably, the light source includes LEDs radiating lights of different colors and arranged in the predetermined direction, and the first light guide plate is provided with a function of color-mixing the lights from the LEDs.

The LCD apparatus of the present invention includes: an LCD panel; and an illumination system which illuminates the LCD panel. The illumination system has: a light source disposed on and facing to the back surface of the LCD panel, and extending in a predetermined direction in a plane substantially parallel to the LCD panel; a first reflector reflecting a light from the light source; a first light guide plate disposed in substantially parallel to the LCD panel to guide the light from the first reflector, the end of which first light guide plate on the incident side is inserted into an opening of the first reflector on the emission side; a second reflector reflecting the light from the first light guide plate; a second light guide plate disposed in substantially parallel to the LCD panel to guide the light from the second reflector; a chassis supporting at least the first reflector, the first light guide plate, the second reflector and the second light guide plate; and a protrusion provided to any of the light source and a support member of the light source to press an area of the first reflector located in the proximity of the first light guide plate toward the first light guide plate.

Preferably, the first reflector of the illumination system includes guides at both ends located in the predetermined direction, the guide projecting in the predetermined direction. The chassis of the illumination system to support both ends of the first reflector includes a reflector support having a flat section which is substantially parallel to the LCD panel, and which touches the guide on the LCD panel side. The reflector support engages with the guide, thereby the first reflector is restricted from moving toward the LCD panel side, and is able to slide in the direction substantially perpendicular to the predetermined direction in the plane substantially parallel to the LCD panel.

According to the illumination system of the present invention, the protrusion can serve to eliminate the gap between the first reflector which reflects the light from the light source and the first light guide plate which the light from the first reflector enters, thereby the light is prevented from leaking from the gap between the first reflector and the first light guide plate. The reason for this is that the protrusion deforms the first reflector, and presses the area of the first reflector located in the proximity of the first light guide plate toward the first light guide plate, allowing the first reflector to securely touch the first light guide plate.

According to the LCD apparatus of the present invention, the gap between the first reflector of the illumination system and the first light guide plate which the light from the first reflector enters can be eliminated, thereby the light is prevented from leaking from the gap between the first reflector and the first light guide plate. The prevention of the light from leaking can lead to the prevention of the occurrence of the unevenness of the luminance of the light emitted from the illumination system. In an LCD apparatus using such an illumination system, the unevenness of the display quality can be suppressed from occurring. The reason for this is that the protrusion of the illumination system deforms the first reflector, and presses the area of the first reflector located in the proximity of the first light guide plate toward the first light guide plate, allowing the first reflector to securely touch the first light guide plate. The intrasurface uniformity of the light emitted from the illumination system is improved. As a result, the unevenness of display quality can be suppressed from occurring in displaying an image utilizing this emitted light.

### BRIEF DESCRIPTION OF THE DRAWINGS

These and other objects and advantages and further description of the invention will be more apparent to those skilled in the art by reference to the description, taken in connection with the accompanying drawings, in which:

FIG. 1 is a plan view diagrammatically showing a structure of an LCD apparatus according to an exemplary embodiment of the present invention;

FIG. 2 is a cross-sectional view of the LCD apparatus of FIG. 1 with an LCD panel placed under the LCD apparatus, taken along the line I-I;

FIG. 3A and FIG. 3B are cross-sectional views diagrammatically showing structures and states, respectively, before and after assembly of a light source and the proximity of a reflector of an illumination system according to the exemplary embodiment of the present invention;

FIG. 4A to FIG. 4C are perspective views diagrammatically showing the structures and states, respectively, before and after assembly of the reflector and a chassis of the illumination system according to the exemplary embodiment of the present invention;

FIG. 5 is a perspective view showing a specific example of the structure of the reflector of the illumination system according to the exemplary embodiment of the present invention;

FIG. 6 is a cross-sectional view diagrammatically showing the structure of the light source and the proximity of the reflector of the illumination system according to the other exemplary embodiment of the present invention;

FIG. 7 is a cross-sectional view diagrammatically showing a structure of an LCD apparatus according to the related art;

FIG. 8 is a cross-sectional view diagrammatically showing a structure of the proximity of a reflector of the LCD apparatus according to the related art; and

FIG. 9A and FIG. 9B are cross-sectional views diagrammatically showing the structures of a light source and the proximity of the reflector of the LCD apparatus according to the related art.

### DETAILED DESCRIPTION OF THE PREFERRED EMBODIMENTS

Prior to describing the preferred embodiments of the present invention, the related art will be described with reference to the drawings.

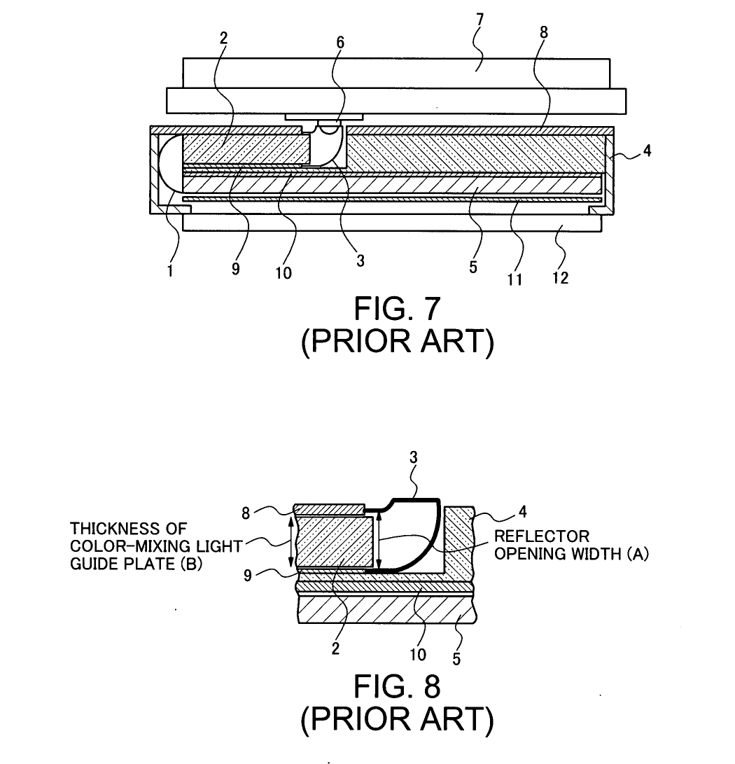

The backlight unit using the light guide plate system described above generally has a structure in which a light source is disposed on a side surface of a light guide plate. When an LED is used as the light source, LEDs, each radiating light of different primary color, are disposed to mix the lights of different primary colors emitted from these LEDs. In case of the lights emitted from the LEDs are color-mixed to obtain a white light, the lights may not sufficiently be color-mixed in the area in the proximity of the light source. The insufficient color mixing results in nonuniform chromaticness over the backlight unit. To solve such a problem, a structure in which a light source such as LEDs 6 are disposed on the back surface of the panel is used as shown in FIG. 7. In this backlight unit, the LED 6 which serves as the light source is arranged to the back surface facing to an LCD panel 12. A color-mixing light guide plate 2 and a light guide plate 5 are disposed substantially in parallel to the LCD panel 12. Furthermore, a reflector 3 is disposed to reflect the light from the light source to the color-mixing light guide plate 2. In addition, a reflector 1 is disposed to reflect the light from the color-mixing light guide plate 2 to the light guide plate 5. In this structure, the lights emitted from the plural LEDs 6 are reflected by the reflector 3, and enters the color-mixing light guide plate 2. In the color-mixing light guide plate 2, the plural different primary colors from the plural LEDs 6 are mixed. For example, a red-colored light, a green-colored light, and a blue-colored light are mixed to provide a white-colored light. The color-mixed light is reflected by the reflector 1, and enters the light guide plate 5. Furthermore, the light which has entered the light guide plate 5 is diffused in the light guide plate 5, and emitted as a backlight to the LCD panel 12.

However, in assembling the backlight unit using the light guide plate system having such a structure, the reflector 3 is engaged with the color-mixing light guide plate 2 as shown in FIG. 8. Accordingly, if the dimensional relationship between a reflector opening width (A) and the thickness of the color-mixing light guide plate (B) is (A)>(B), the light is likely to leak from the gap between the reflector 3 and the color-mixing light guide plate 2.

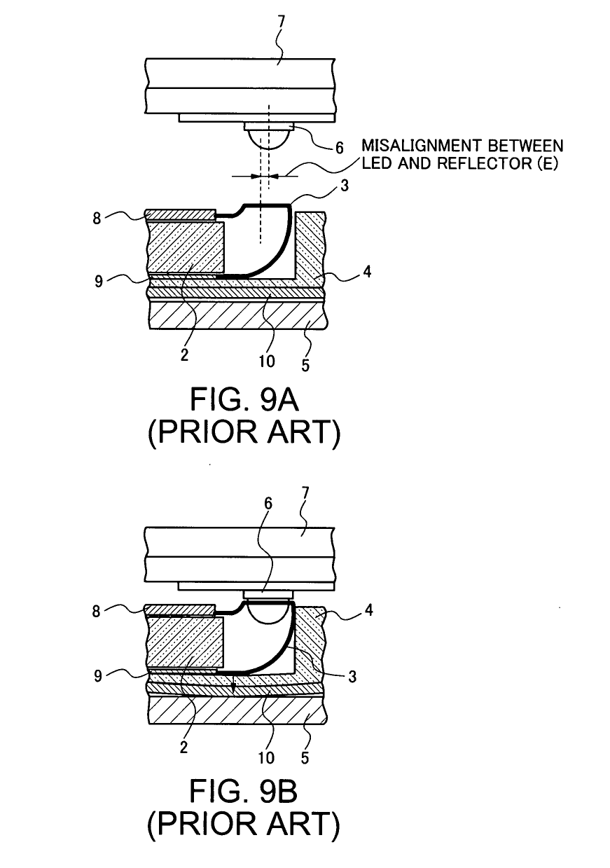

Moreover, in the backlight unit using the light guide plate system having the structure described above, when the mounting misalignment of the LED 6 and the warpage of the reflector 3 occur, the centerline of the LED 6 and the centerline of the reflector 3 could be misaligned with each other as shown in FIG. 9A. As a result, the LED 6 and the reflector 3 interact with each other at the time of mounting them. This interaction causes the reflector 3 to be pushed by the LED 6. The reflector 3 in turn pushes a reflection sheet 10. Thus, the clearance between the reflection sheet 10 and the light guide plate 5 is possibly varied as shown in FIG. 9B. As a result, the luminance of the display surface becomes nonuniform. This nonuniformity could cause the occurrence of the unevenness of display quality in the LCD apparatus using this backlight unit. Moreover, there is a problem that the light leaks from the gap between the LED 6 and the reflector 3 because the LED 6 is not fully accommodated in the reflector 3.

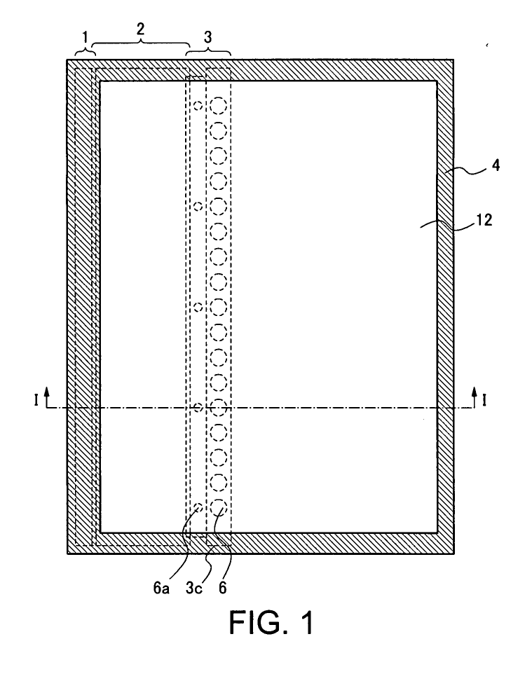

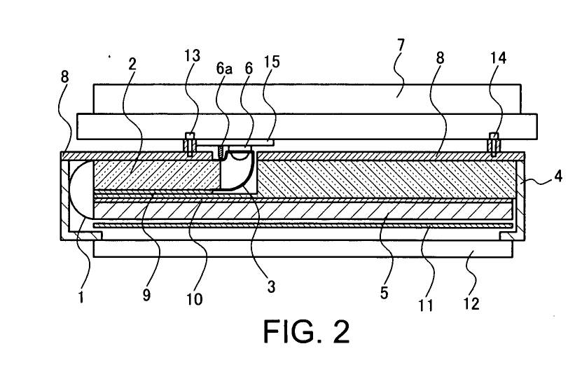

For these reasons, in the present invention, a protrusion, for example, a pressing protrusion 6a is provided to a support member of a light source or the light source as shown in FIG. 1 and FIG. 2. The protrusion, for example, the pressing protrusion 6a, is preferably molded to the support member of the light source or the light source in a single piece. An area of a reflector 3 located in the proximity of a color-mixing light guide plate 2 is pressed by the pressing protrusion 6a to complete a structure in which the reflector 3 securely touches the color-mixing light guide plate 2. In addition, guides 3c are provided to both ends of the reflector 3. The guides 3c are preferably molded to both ends of the reflector 3 in a single piece. Furthermore, reflector supports 4a which touch the guides 3c of the reflector 3 are provided to a chassis 4. The reflector supports 4a are preferably molded to the chassis 4 in a single piece. A structure is formed in which the reflector 3 can be slid substantially in parallel to an LCD panel 12 while the guides 3c of the reflector 3 are supported by the reflector supports 4a of the chassis 4. This structure allows the lights to be prevented from leaking from the gaps between the reflector 3 and the color-mixing light guide plate 2, and between the light source, for example, LED 6, and the reflector 3. Moreover, even when the positional relationship between the light source, for example, LED 6, and the reflector 3 is changed, the occurrence of the unevenness of display quality due to the positional misalignment can be suppressed by correcting the positional relationship.

To describe the present invention in more details, an illumination system related to the exemplary embodiments of the present invention and an LCD apparatus equipped with the illumination system are described with reference to FIG. 1 to FIG. 5.

The LCD apparatus of the present embodiment is mainly constructed of an LCD panel 12 and an illumination system which irradiates the LCD panel 12 with a backlight as shown in FIG. 1 and FIG. 2. Various kinds of shapes, structures, and driving methods can be employed for the LCD panel 12.

The LCD panel 12 is constructed by sandwiching a liquid crystal material between a first substrate and a second substrate. On the first substrate, a switching element such as a thin film transistor (TFT) is formed in each pixel arranged in a matrix pattern, and on the second substrate, a color filter and a black matrix, for example, are formed.

The illumination system of the present embodiment is mainly constructed of a light source section and a light guide section. The illumination system of the present embodiment constructs a backlight unit which irradiates the LCD panel 12 with the backlight.

The light source section is constructed of a light source such as the LED 6 or the cold cathode lamp, a base seat 15 for supporting and fixing a plural of the arranged light sources, and a heat sink 7 for outwardly diffusing the heat generated at the light sources. To be more specific, a heat sink 7 formed of a material having a high thermal conductivity is provided to radiate the heat generated by the LED 6. The base seat 15 is fixed on the under side of the heat sink 7. The plural LEDs 6 are arranged on the base seat 15 in a predetermined direction. The plural LEDs 6 are arranged in the order of, for example, an LED which emits red color light, an LED which emits green color light, and an LED which emits blue color light, and then used. A pressing protrusions 6a for pressing a reflector 3 in the area thereof in the proximity of a color-mixing light guide plate 2 are provided to the base seat 15 in the proximity of the several LEDs 6 among the plural LEDs 6. “The under side of the heat sink 7 on which the LEDs 6 are arranged” is a surface of the heat sink 7 on the side of the LCD panel 12. The predetermined direction in which the LEDs 6 are arranged is the longitudinal direction of the LCD panel 12 as shown in FIG. 1.

The light guide section is mainly constructed of the reflector 3, the color-mixing light guide plate 2, a reflector 1, a light guide plate 5, reflection sheets 9 and 10, an optical sheet 11, a chassis 4 and a frame 8. The reflector 3 reflects the light emitted from the light source 6. The color-mixing light guide plate 2 color-mixes the light reflected by the reflector 3. The reflector 1 reflects the color-mixed light emitted from the color-mixing light guide plate 2. The light guide plate 5 diffuses the light reflected by the reflector 1, and guides the light to the entire surface of the LCD panel 12. The reflection sheets 9 and 10 reflect the lights leaked from the color-mixing light guide plate 2 and the light guide plate 5, respectively, to return the lights to the color-mixing light guide plate 2 and the light guide plate 5. The optical sheet 11 diffuses, collects, and polarizes the light emitted from the light guide plate 5. The chassis 4 is made of resin or the like. The frame 8 is made of metal or the like. The chassis 4 and frame 8 accommodate and support the optical members described above.

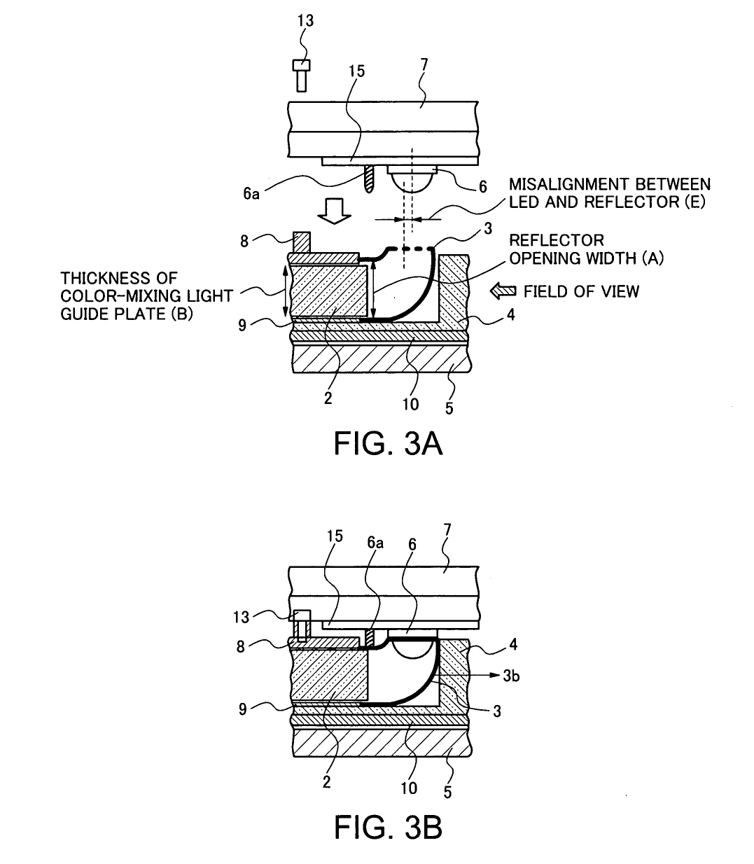

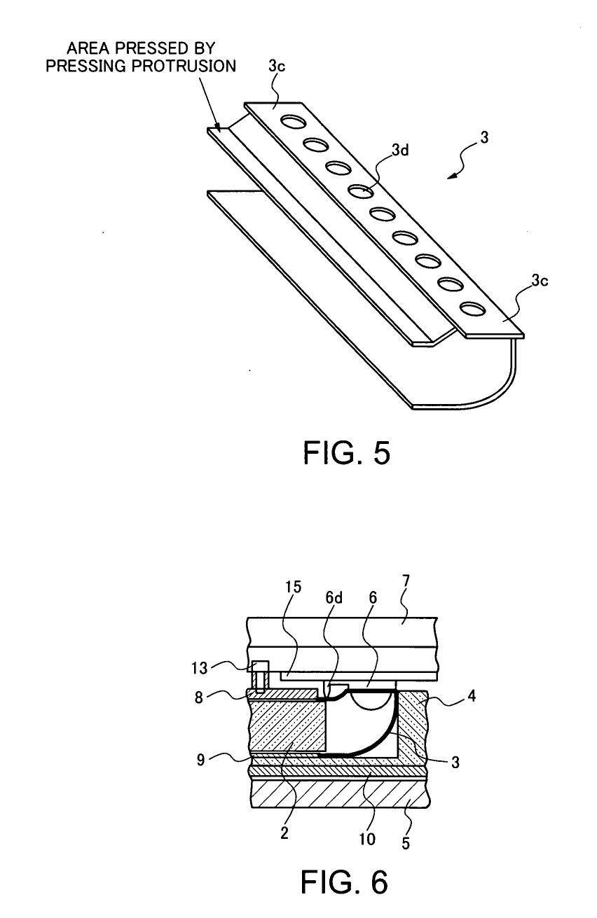

The reflector 3 will specifically be described with reference to FIG. 3A and FIG. 5. The reflector 3 is formed of a metal plate or the like, and mounted in the position facing to the plural LEDs 6 as shown in FIG. 3A. The reflector 3 serves to bend the light emitted from the LED 6 substantially 90 degrees in a direction perpendicular to the direction in which the LEDs are arranged, i.e. the longitudinal direction of the LCD panel 12 so as to take the light into the color-mixing light guide plate 2. Openings 3d for the LEDs through which the LEDs 6 are inserted are formed in the reflector 3 along the direction in which the LEDs 6 are arranged as shown in FIG. 5. The reflector 3 is elastically deformably formed so that an opening for the reflector (A) becomes narrow by a pressing action of the pressing protrusion 6a. Guides 3c are formed at both ends of the reflector 3, i.e. both ends of the direction in which the LEDs 6 are arranged, as shown in FIG. 5. The guides 3c of the reflector 3 engages with the reflector support 4a of the chassis 4 described below.

A light guide plate which is made of a transparent plastic resin plate substantially parallel to the LCD panel 12 is disposed in an opening of the reflector 3 on the emission side. Here, the light guide plate is to the color-mixing light guide plate 2. The reflection sheet 9 is disposed on the under side of the color-mixing light guide plate 2. The reflection sheet 9 is for reflecting the light leaked from the color-mixing light guide plate 2 to return the light to the color-mixing light guide plate 2, and improves the efficiency of propagating the light in the color-mixing light guide plate 2. “The under side of the color-mixing light guide plate 2” is a surface of the color-mixing light guide plate 2 on the side of the LCD panel 12.

The reflector 1 is disposed at the end of the color-mixing light guide plate 2 on the emission side. The reflector 1 is formed of a metal plate and the like to bend the light propagated in the color-mixing light guide plate 2 substantially 180 degrees. The light guide plate 5 is disposed in the opening of the reflector 1 on the emission side. The light guide plate 5 is made of a transparent plastic resin plate substantially parallel to the LCD panel 12. The reflection sheet 10 is disposed on the upper side of the light guide plate 5. The reflection sheet 10 is for reflecting the light leaked from the light guide plate 5 to return the light to the light guide plate 5, and improves the efficiency of propagating the light in the light guide plate 5. Here, “the upper side of the light guide plate 5” is the surface of the light guide plate 5 on the side of the LED 6. The light emitted from the under side of the light guide plate 5 illuminates the LCD panel 12 via the optical sheet 11 which allows uniform irradiation. Here, “the under side of the light guide plate 5” is the surface of the light guide plate 5 on the side of the LCD panel 12.

Note that, the present invention is characterized by the structure of the LED 6, the reflector 3, and the chassis 4. The material, shape, structure and the like of the other members are not specifically limited. Thus, free design thereof is permitted. In the present embodiment, the LEDs 6 are in a combination of LEDs radiating lights of different colors, and color mixing is performed in the color-mixing light guide plate 2. However, the LED 6 may be monochromatic, and diffusion and mixing only may be carried out in the color-mixing light guide plate 2. A structure in which the plural monochromatic LEDs 6 are arranged to diffuse and mix the lights emitted therefrom improves the intrasurface uniformity of the luminance of the light emitted from the illumination system as compared to the structure in which a single light source is disposed. In FIG. 1, the LEDs 6 are arranged in the longitudinal direction of the LCD panel 12. Alternatively, the LEDs 6 may be arranged in the direction perpendicular to the longitudinal direction. The positions of the LEDs 6 are not limited to the ones shown in FIG. 1, and can suitably be changed according to the shape of the color-mixing light guide plate 2.

In the illumination system of the present embodiment, the reflector 3 is assembled by engaging with the color-mixing light guide plate 2. Accordingly, the dimensional relationship between a reflector opening width (A) and the thickness of the color-mixing light guide plate (B) is (A)>(B). Thus, prior to the setting of the LEDs 6, there exists a gap between the color-mixing light guide plate 2 and the reflector 3 as shown in FIG. 3A. The light possibly leaks from this gap. In the present embodiment, as an example of the support member for the light source, the pressing protrusion 6a is disposed to the base seat 15 which supports the LED 6. The pressing protrusion 6a presses the area of the reflector 3 located in the proximity of the color-mixing light guide plate 2. As shown in FIG. 3B, when the light source section is set to the light guide section, the pressing protrusion 6a presses the reflector 3, thereby the area of the reflector 3 on the LED 6 side is deformed, causing the reflector 3 to touch the color-mixing light guide plate 2. The action of the pressing protrusion 6a can serve to prevent the light from leaking from the gap between the color-mixing light guide plate 2 and the reflector 3. In such a setting state, the heat sink 7 of the light source section is fixed to the frame 8 of the light guide section with screws 13 and 14.

Note that, FIG. 3A and FIG. 3B show the single pressing protrusion 6a. However, the quantity, shape, height, and arrangement of the pressing protrusion 6a are optional. A structure which allows the secure prevention of the light from leaking from the gap between the reflector 3 and the color-mixing light guide plate 2 should serve for the purpose of the present embodiment. For example, the pressing protrusions 6a may be provided to each LED 6. Alternatively, the pressing protrusions 6a may be provided at predetermined space as shown in FIG. 1. The reflector 3 may be deformable so that the opening for the reflector (A) becomes narrower by the pressing force of the pressing protrusion 6a. The structure thereof is not limited. However, for example, the structure thereof can be formed by bending a metal plate having a predetermined thickness is available as shown in FIG. 5. Specifically, the structure is formed so as to include: a first surface having the openings 3d for the LED through which the LEDs 6 are inserted; a second surface which is connected with a side extending along the longitudinal direction of the first surface and extends to the back surface of the color-mixing light guide plate 2; and a third surface which is connected with another side extending along the longitudinal direction of the first surface, and extends to the front surface side of the color-mixing light guide plate 2.

The roles of the guide 3c provided to the reflector 3 and the reflector support 4a provided to the chassis 4 will then be described. In case of the misalignment (E) between the LED and the reflector is large as shown in FIG. 3A, the LED 6 and the reflector 3 interact with each other. As a result, the LED 6 pushes the reflector 3 toward the LCD panel 12. The pushed reflector 3 in turn pushes the frame 4 and further the reflection sheet 10. This causes the clearance between the reflection sheet 10 and the light guide plate 5 to vary. Thus, the luminance of the display surface of the illumination system becomes nonuniform, resulting in the possibility of the occurrence of display unevenness.

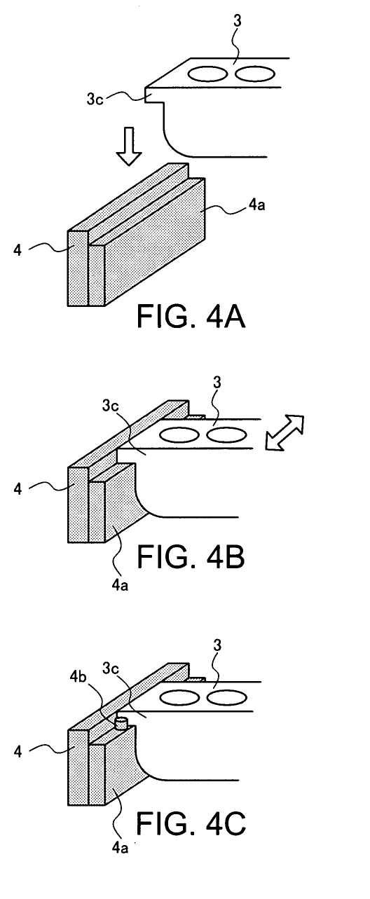

For this reason, in the present embodiment, the guides 3c projecting in the LED 6 arrangement direction are provided at both ends of the reflector 3 as shown in FIG. 4A. “Both ends of the reflector 3” are each end located in the LED 6 arrangement direction. Furthermore, the reflector support 4a is provided to the chassis 4 in the position facing to the guide 3c of the reflector 3. The reflector support 4a has a flat surface substantially parallel to the surface of the LCD panel 12. The structure in which the guide 3c on the side of the LCD panel 12 is received on the flat surface of the reflector support 4a is employed. This structure causes the reflector 3 pushed by the LED 6 to slide toward reflector slide directions 3b shown by a arrow in FIG. 3B even when the LED 6 presses the reflector 3 toward the LCD panel 12. This slide corrects the misalignment between the LED 6 and the reflector 3. The stress to the display surface side, i.e. here to the side of the LCD panel 12 is thus suppressed. As a result, it is possible to suppress the occurrence of the unevenness of the display quality, i.e. nonuniformity of luminance of the display surface caused by the variations of the clearance between the reflection sheet 10 and the light guide plate 5. In addition, the misalignment between the LED 6 and the reflector 3 is simultaneously eliminated. Thus, the light can be prevented from leaking from the gap between the LED 6 and the reflector 3.

A structure which allows the reflector 3 to slide without any restriction in the direction perpendicular to the LED 6 arrangement direction is employed in FIG. 4A and FIG. 4B. The reflector 3 may be caused to slide in a restricted area by providing a stopper 4b in a predetermined position in the reflector support 4a as shown in FIG. 4c.

Each of the structures shown in FIG. 4A to FIG. 4C is an exemplification. If the reflector 3 can be restricted from moving toward the LCD panel 12, the shapes, arrangements, structures and the like of the guide 3c, the reflector support 4a, and the stopper 4b can be appropriately changed. That is, as long as the unevenness of the luminance of the light having band shape generated when the reflector 3 presses the reflection sheet 10 can be suppressed from occurring, the shapes, arrangements, structures and the like of the guide 3c, the reflector support 4a, and the stopper 4b can be appropriately changed.

In the above manner, the pressing protrusion 6a is provided to the base seat 15 which supports the LED 6. The reflector 3 is pressed toward the color-mixing light guide plate 2 by the pressing protrusion 6a. Accordingly, the reflector 3 securely touches the color-mixing light guide plate 2. This touch can prevent the light from leaking from the gap between the reflector 3 and the color-mixing light guide plate 2. Moreover, the guides 3c are provided at both ends of the reflector 3 as well as the reflector support 4a is provided on the chassis 4. A structure in which the guide 3c is received on the reflector support 4a is employed, resulting in the prevention of the light from leaking from the gap between the LED 6 and the reflector 3. Furthermore, even when the positional relationship is misaligned between the LED 6 and the reflector 3, the correcting of the positional relationship can suppress the occurrence of the unevenness of luminance of the illumination system caused by the positional misalignment. Because the unevenness of the luminance of the illumination system can thus be prevented from occurring, the unevenness of the display quality of the LCD apparatus using the illumination system can be prevented from occurring.

Note that, in the above embodiment, described has been the structure in which two light guide plates including the color-mixing light guide plate 2 and the light guide plate 5 are provided. However, the embodiment can be applied in the structure in which a single light guide plate is provided (a structure in which the reflector 1 and the light guide plate 5 are omitted). The present embodiment has described the case where the illumination system of the present invention is utilized in the LCD apparatus. However, the illumination system of the present invention is not limited to the above embodiment, and can be used for the illumination system which illuminates a given member to be illuminated in the same manner as above.

Furthermore, the embodiment described above has described the case where the pressing protrusions 6a are provided to the base seat 15 which supports the plural LCD 6. However, the pressing protrusion is molded to the LED in a single piece. The LED molded in a single piece in such a manner may be used. Description will be given of an illumination system of the other exemplary embodiment of the present invention and an LCD apparatus using this illumination system with reference to FIG. 6. In the present embodiment, a protrusion, for example, a pressing protrusion 6b is molded to the LED 6 in a single piece. Such an LED 6 molded in a single piece is fixed on the base seat 15. The base seat 15 is fixed to the heat sink 7 formed of a member having a high thermal conductivity. When the light source section is set to the light guide section as shown FIG. 6, the pressing protrusion 6a of the LED 6 pushes the reflector 3. Then, the reflector 3 on the LED 6 side is so deformed that the reflector 3 touches the color-mixing light guide plate 2. This touch thus allows the prevention of the light from leaking from the gap between the color-mixing light guide plate 2 and the reflector 3. While the light source section is thus set, the heat sink 7 of the light source section is fixed to the frame 8 of the light guide section using the screws 13 and 14. All of LEDs 16 fixed to the base seat 15 may serve as LED 6 to which the pressing protrusion 6b is molded in a single piece. Alternatively, as shown in FIG. 1, the LEDs 6 to which the pressing protrusion 6b is molded in a single piece may be arranged at predetermined space. Otherwise, the LEDs 6 having no pressing protrusion 6b may be arranged therebetween.

The present invention can be utilized in an illumination system using a light guide plate, a given type of LCD apparatus equipped with the illumination system, and a given type of instrument equipped with the LCD apparatus as display means.

Although preferred embodiments of the invention has been described with reference to the drawings, it will be obvious to those skilled in the art that various changes or modifications may be made without departing from the true scope of the invention.

What is claimed is:

1. An illumination system comprising:
a light source disposed on and facing to the back surface of an irradiated body, and extending in a predetermined direction in a plane substantially parallel to the irradiated body;
a first reflector reflecting a light from the light source;
a first light guide plate disposed in substantially parallel to the irradiated body to guide the light from the first reflector, the end of which first light guide plate on the incident side is inserted into an opening of the first reflector on the emission side;
a second reflector reflecting the light from the first light guide plate;
a second light guide plate disposed in substantially parallel to the irradiated body, and guiding the light from the second reflector;
a chassis supporting at least the first reflector, the first light guide plate, the second reflector and the second light guide plate; and
a protrusion provided to any of the light source and a support member of the light source to press an area of the first reflector in the proximity of the first light guide plate toward the first light guide plate.

2. The illumination system according to claim 1, wherein the protrusion is molded to any of the light source and the support member of the light source in a single piece.

3. The illumination system according to claim 1, wherein the first reflector includes: a first surface provided with an opening through which the light source is inserted; a second surface which is connected with one side of the first surface, and which extends toward the back surface of the first light guide plate; and a third surface which is connected with one side opposite to the above-mentioned one side of the first surface, and which extends toward the front surface of the first light guide plate, wherein the protrusion presses the second surface toward the third surface side to narrow the space between the second surface and the third surface.

4. The illumination system according to claim 1, wherein the first reflector includes guides at both ends located in the predetermined direction, the guide projecting in the predetermined direction,
the chassis to support both ends of the first reflector includes a reflector support having a flat section which is substantially parallel to the irradiated body, and which touches the guide on the irradiated body side, and
the reflector support engages with the guide, thereby the first reflector is restricted from moving toward the irradiated body side, and is able to slide in the direction substantially perpendicular to the predetermined direction in the plane substantially parallel to the irradiated body.

5. The illumination system according to claim 4, wherein the guide is molded to the first reflector in a single piece, and the reflector support is molded to the chassis in a single piece.

6. The illumination system according to claim 1, wherein the light source includes LEDs radiating lights of different colors and arranged in the predetermined direction, and the first light guide plate is provided with a function of color-mixing the lights from the LEDs.

7. A liquid crystal display apparatus comprising:
a liquid crystal display panel; and
an illumination system for illuminating the liquid crystal display panel, the illumination system including:
a light source disposed on and facing to the back surface of the liquid crystal display panel, and extending in a predetermined direction in a surface substantially parallel to the liquid crystal display panel;
a first reflector reflecting a light from the light source;
a first light guide plate disposed in substantially parallel to the liquid crystal display panel to guide the light from the first reflector, the end of which first light guide plate on the incident side is inserted into an opening of the first reflector on the emission side;
a second reflector reflecting the light from the first light guide plate;
a second light guide plate disposed in substantially parallel to the liquid crystal display panel to guide the light from the second reflector;
a chassis supporting at least the first reflector, the first light guide plate, the second reflector and the second light guide plate; and
a protrusion provided to any of the light source and a support member of the light source to press an area of the first reflector located in the proximity of the first light guide plate toward the first light guide plate.

8. The liquid crystal display apparatus according to claim 7, wherein the protrusion of the illumination system is molded to any of the light source and the support member of the light source in a single piece.

9. The liquid crystal display apparatus according to claim 7, wherein the first reflector of the illumination system includes: a first surface provided with an opening through which the light source is inserted; a second surface which is connected with one side of the first surface, and which extends toward the back surface of the first light guide; and a third surface which is connected with one side opposite to the above-mentioned one side of the first surface, and which extends toward the front surface of the first light guide plate, wherein the protrusion presses the second surface toward the third surface side to narrow the space between the second surface and the third surface.

10. The liquid crystal display apparatus according to claim 7, wherein the first reflector of the illumination system includes guides at both ends located in the predetermined direction, the guide projecting in the predetermined direction,
the chassis of the illumination system to support both ends of the first reflector includes a reflector support having a flat section which is substantially parallel to the liquid crystal display panel, and which touches the guide on the liquid crystal display panel side, and
the reflector support engages with the guide, thereby the first reflector is restricted from moving toward the liquid crystal display panel side, and is able to slide in the direction substantially perpendicular to the predetermined direction in the plane substantially parallel to the liquid crystal display panel.

11. The liquid crystal display apparatus according to claim 10, wherein the guide is molded to the first reflector in a single piece, and the reflector support is molded to the chassis in a single piece.

12. The liquid crystal display apparatus according to claim 7, wherein the light source of the illumination system includes LEDs radiating lights of different colors and arranged in the predetermined direction, and the first light guide plate of the illumination system provided with a function of color-mixing the lights from the LED.
